(19) United States
(12) Patent Application Publication
(10) Pub. No.: US 2007/0196199 A1
(43) Pub. Date: Aug. 23, 2007

(54) LIFTING AND HAULING APPARATUS

(75) Inventor: Jerry A. Evans, North Springs, WV (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: Shelia Evans, North Springs, WV (US)

(21) Appl. No.: 11/456,699

(22) Filed: Jul. 11, 2006

Related U.S. Application Data
(60) Provisional application No. 60/766,928, filed on Feb. 21, 2006.

(51) Int. Cl. B62D 43/00

(52) U.S. Cl. 414/466

(57) ABSTRACT

A lifting and hauling apparatus capable of being used with vehicles. The lifting and hauling apparatus includes an attachment means, a platform, at least one support member, and a moving means. The attachment means releasably secures the apparatus to the vehicle. The platform is connected to the attachment means and movable between a lowered loading position and a raised hauling position. The at least one support member connects the platform to the attachment means and is adapted to vary a distance between the platform and the attachment means. The moving means moves the platform between the lowered loading position and the raised hauling position.

### CROSS-REFERENCE TO RELATED APPLICATIONS

This application claims the benefit of Provisional Application No. 60/766,928 filed on Feb. 21, 2006.

### TECHNICAL FIELD AND BACKGROUND OF THE INVENTION

The present invention relates to a lifting and hauling apparatus, and more particularly to a lifting and hauling apparatus capable of being used with vehicles having a trailer hitch.

There are many types of lifting and hauling apparatuses used today. However, many lifting and hauling apparatuses, such as fork lifts and high-lifts, are too expensive and impracticable to be used everyday by individuals who need a way to perform simple chores around the house or simply lift and haul heavy items from one place to another.

For example, individuals who burn wood to heat their home need a way to haul firewood to their house. Typically, a pick-up truck or wheelbarrow is used to haul firewood, but they require the individual to load the firewood into the pick-up truck or wheel barrow, and some individuals are not capable of doing so.

Another example where a lifting and hauling apparatus may be used is hunting. Typically, hunters who have taken a big game animal, such as a deer, must drag the animal out of the wilderness and then lift the animal into a vehicle. This can be very tiring and time consuming, especially if the hunter has trekked several miles into the wilderness. Some hunters now use an all-terrain vehicle (ATV) to haul the animal out of the wilderness, but the individual must still lift the animal onto the ATV, risking injury.

Accordingly, there is a need for a lifting and hauling apparatus that can be used by individuals to lift heavy items and haul those items to a desired location easily.

### SUMMARY OF THE INVENTION

Therefore it is an object of the invention to provide a lifting and hauling apparatus that allows an individual to lift and haul heavy items such as firewood and big game animals.

It is another object of the invention to provide a lifting and hauling apparatus that may be attached to a vehicle having a trailer hitch.

These and other objects of the present invention are achieved in the preferred embodiments disclosed below by providing a lifting and hauling apparatus including an attachment means for releasably securing the apparatus to a vehicle; a platform connected to the attachment means and movable between a loading position and a hauling position; at least one support member for connecting the platform to the attachment means, the at least one support member being adapted to vary a distance between the platform and the attachment means; and a moving means for moving the platform between the loading position and the hauling position.

According to another preferred embodiment of the invention, the attachment means is adapted to be received in a hitch of the vehicle.

According to another preferred embodiment of the invention, the platform is pivotally connected to at least one support member.

According to another preferred embodiment of the invention, an adjustment member pivotally connects to the platform to selectively pivot the platform relative to at least one support member.

According to another preferred embodiment of the invention, the platform is adapted to be connected to at least one adjustment member for selectively pivoting the platform relative to the attachment means.

According to another preferred embodiment of the invention, the platform is adapted to be secured to the vehicle while in the hauling position.

According to another preferred embodiment of the invention, a lifting and hauling apparatus is mounted to a vehicle and includes a platform assembly having an attachment member adapted to be releasably secured to the vehicle, at least one support member carried by and moveable relative to the attachment member, and a platform carried by the support member and adapted for hauling items thereupon. The apparatus further includes a lifting assembly operably connected to the platform assembly and adapted to be connected to the vehicle for moving the platform between a lowered loading position and a raised hauling position.

According to another preferred embodiment of the invention, the attachment member is adapted to be received in a hitch of the vehicle.

According to another preferred embodiment of the invention, the lifting assembly includes a winch for moving the platform between the loading position and the hauling position.

According to another preferred embodiment of the invention, the winch is releasably secured to a hitch of the vehicle.

According to another preferred embodiment of the invention, the lifting and hauling apparatus further includes an adjustment member having a first end pivotally connected to the platform and a second end for being releasably secured to the at least one support member, where the adjustment member is adapted to selectively pivot the platform relative to the at least one support member.

According to another preferred embodiment of the invention, the at least one support member includes an inner member slidably engaged with an outer member to allow the at least one support member to be adjusted in length.

According to another preferred embodiment of the invention, a lifting and hauling apparatus for being mounted to a vehicle includes a platform assembly having an attachment member that can be received into an opening of a hitch of the vehicle, at least one support member connected to the attachment member, and a platform carried by the at least one support member and adapted for hauling items thereupon. The apparatus further including a lifting assembly operably connected to the platform assembly and connected to the vehicle for moving the platform between a lowered loading position and a raised hauling position. The lifting assembly having a winch carried by the hitch, a pulley assembly carried by the vehicle, and a cable extending through the pulley assembly and interconnecting the platform and the winch, wherein the winch is adapted to manipulate the cable to move the platform between the raised hauling position and the lowered loading position.

According to another preferred embodiment of the invention, the inner and outer members include a plurality of apertures for allowing a fastener to pass therethrough and secure the inner member to the outer member.

According to another preferred embodiment of the invention, the second end of the adjustment member includes a plurality of apertures for being aligned with an aperture in at least one support member and secured thereto by a fastener passing through the aligned apertures so as to allow the platform to be selectively pivoted with respect to the at least one support member.

According to another preferred embodiment of the invention, the platform is concave in shape.

According to another preferred embodiment of the invention, the platform further includes a tube frame surrounding a mesh surface.

According to another preferred embodiment of the invention, the attachment member is adapted to slide into the opening of the hitch and the winch is adapted to slide over the hitch such that at least one aperture on the winch, hitch, and attachment member are aligned and adapted to receive a fastener therethrough.

According to another preferred embodiment of the invention, the at least one support member is pivotally connected to the attachment member by a transverse member.

According to another preferred embodiment of the invention, the pulley assembly is adapted to be attached to the vehicle at a location above the winch so as to allow the winch to move the platform to the hauling position.

According to another preferred embodiment of the invention, the platform is adapted to receive a hook, which is connected to an end of the cable opposite of the winch for releasably connecting the platform to the winch using the cable and further allows the winch to move the platform between the loading and hauling positions.

### BRIEF DESCRIPTION OF THE DRAWINGS

The invention may be best understood by reference to the following description in conjunction with the accompanying drawing figures in which:

FIG. 1 shows a lifting and hauling apparatus according to an embodiment of the invention;

FIG. 2 shows the adjustment of a platform assembly of the lifting and hauling apparatus of FIG. 1;

FIG. 3 is an exploded view showing attachment of the platform assembly and a lifting assembly of the lifting and hauling apparatus of FIG. 1 to a hitch on a vehicle;

FIG. 4 is a perspective view of the lifting and hauling apparatus of FIG. 1 attached to an all-terrain vehicle in an upright/hauling position;

FIG. 5 is a perspective view of the lifting and hauling apparatus of FIG. 1 attached to an all-terrain vehicle in a loading position;

FIG. 6 shows the lifting and hauling apparatus of FIG. 1 being secured to a frame of a vehicle in the upright/hauling position shown in FIG. 4.

### DESCRIPTION OF THE PREFERRED EMBODIMENT AND BEST MODE

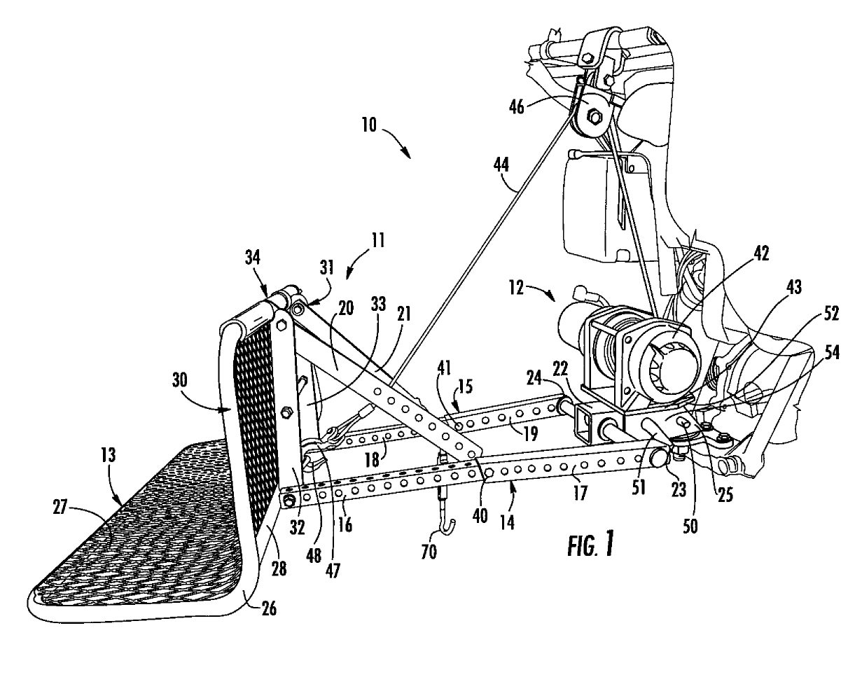

Referring now specifically to the drawings, a lifting and hauling apparatus according to an embodiment of the invention is illustrated in FIG. 1 and shown generally at reference numeral 10. The apparatus 10 includes a platform assembly 11 and a lifting assembly 12.

The platform assembly 11 includes a platform 13 pivotally attached to a pair of support members 14 and 15 having inner and outer support members 16, 18 and 17, 19, and a pair of adjustment members 20 and 21. An attachment member 22 is pivotally attached to and disposed between ends 23 and 24 of the support members 14 and 15. The attachment member 22 allows the apparatus 10 to be attached to a standard receiver-type hitch having a rectangular opening. Accordingly, the apparatus 10 may be attached to any vehicle, such as a pick-up truck or an all-terrain vehicle, having such a hitch. For purposes of this discussion, the apparatus 10 is shown attached to an all-terrain vehicle.

The platform 13 includes a frame 26 with a platform surface 27 attached thereto. As illustrated, the platform surface is a wire mesh; however, other suitable surfaces such as a solid sheet may be used. As illustrated, the frame 26 is formed of a one-piece tubing; however, the frame 26 may be constructed of a plurality of tubing pieces or other suitable structural pieces. The platform 13 also includes a cross-piece 28 extending between opposing sides 30 and 31 of the platform 13, and supports 32 and 33 extending between the cross-piece 28 and a front 34 of the platform 13. The supports 32 and 33 provide additional strength to the platform 13 and allow the support members 14 and 15 and adjustment members 20 and 21 to be pivotally attached to the platform 13.

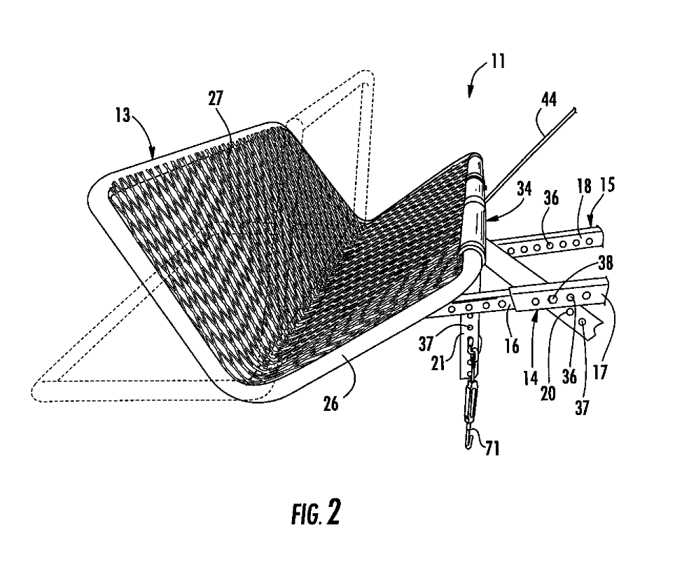

As shown in FIG. 2, the platform 13 can be pivoted to allow the platform 13 to have different angles relative to the support members 14 and 15. As shown, the support members 14 and 15 include apertures 36 and the adjustment members 20 and 21 have apertures 37. The angle of the platform 13 may be adjusted by changing the position of the adjustment members 20 and 21 relative to the support members 14 and 15. Once the desired position angle has been obtained, the platform 13 is secured in that angle by positioning fasteners 38 through the aligned apertures 36 and 37.

The length of the platform assembly 11 may also be changed by removing fasteners 40 and 41 from apertures 36 and sliding the inner support members 16 and 18 within the outer support members 17 and 19 to the desired length. The fasteners 40 and 41 are then inserted into the apertures 36 to secure the platform assembly 11 at that length.

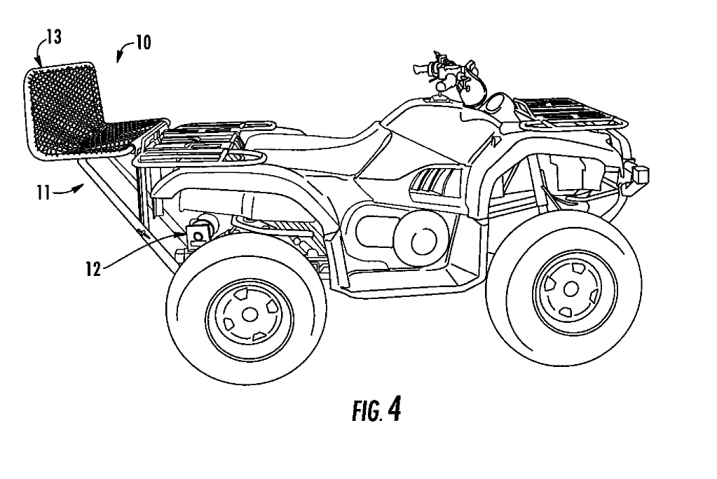

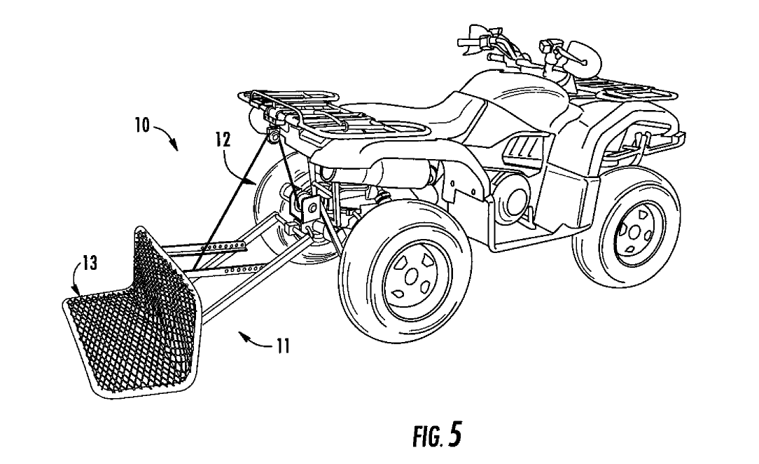

Referring again to FIG. 1, the lifting assembly 12 includes a winch 42 attached to the hitch 25 by a mounting bracket 43. A cable 44 wound on the winch 42 extends from the winch 42 through a pulley assembly 46 to the platform 13. A hook 47 positioned on the end of the cable 44 engages a lifting loop 48 carried by the platform 13 to allow the winch 42 to lift or lower the platform assembly 11 between a loading position, FIG. 5, and an upright/hauling position, FIG. 4. When in the loading position, an item may be slid or rolled onto the platform 13, thereby eliminating the need to lift the item and risk injury.

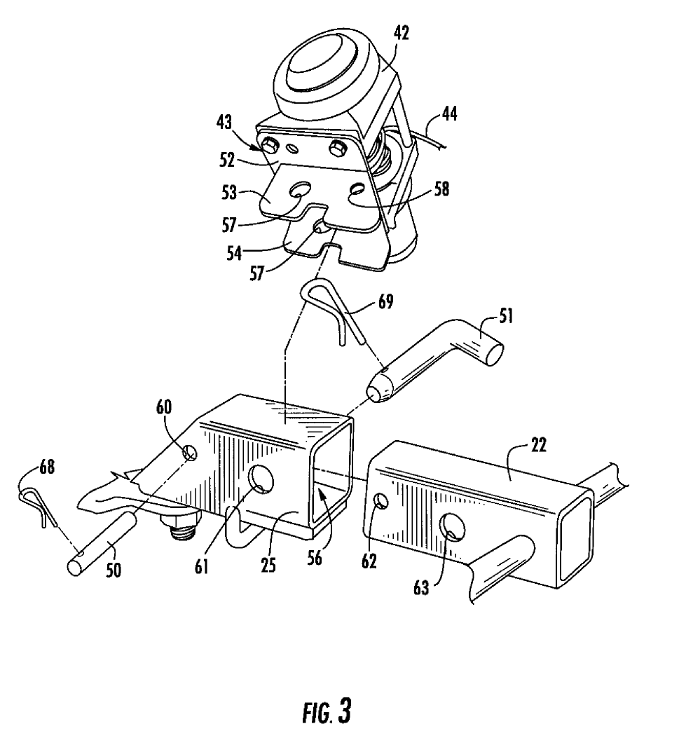

As shown in FIG. 3, the platform assembly 11 and lifting assembly 12 are secured to the hitch 25 by fasteners, such as pins 50 and 51. The mounting bracket 43 includes a plate 52 connected to the winch 42 and a pair of spaced-apart side plates 53 and 54 extending downwardly from the plate 52 for being positioned on opposing sides of the hitch 25. The mounting bracket 43 is positioned over the hitch 25 such that the side plates 53 and 54 reside adjacent to opposing sides of the hitch 25, and apertures 57 and 58 on the mounting bracket 43 are aligned with apertures 60 and 61 on the hitch 25, respectively.

The attachment member 22 is slid into the opening 56 of the hitch 25 until apertures 62 and 63 on the attachment member 22 are aligned with apertures 57, 60 and 58, 61, respectively. Pins 50 and 51 are positioned through apertures 57, 60, 62 and 58, 61, 63, respectively, to secure the lifting assembly 12 and platform assembly 11 to the hitch 25. The pins 50 and 51 are then locked in position by cotter pins 68 and 69.

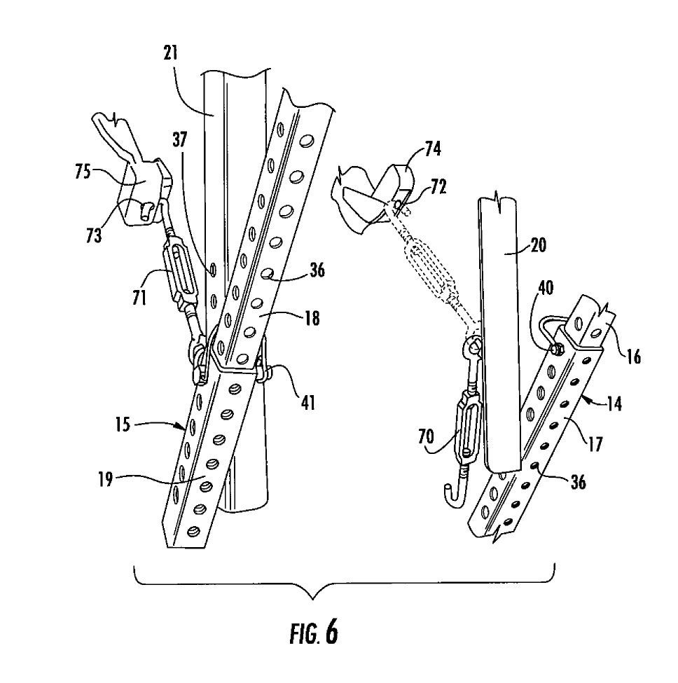

Referring to FIG. 6, when the platform assembly 11 is in the upright/hauling position, the platform assembly 11 may be secured in that position by a pair of securing members 70 and 71. As shown, the securing members 70 and 71 are connected to the adjustment members 20 and 21. When in the hauling position, the securing members 70 and 71 may be attached to apertures 72 and 73 positioned on frame members 74 and 75 of a vehicle, thereby securing the platform assembly 11 to the vehicle in a hauling position, thus, the lifting assembly 12 can be disengaged from the platform assembly. As illustrated, the securing members 70 and 71 are adjustable.

A lifting and hauling apparatus is described above. Various details of the invention may be changed without departing from its scope. Furthermore, the foregoing description of the preferred embodiments of the invention and best mode for practicing the invention are provided for the purpose of illustration only and not for the purpose of limitation.

I claim:

1. A lifting and hauling apparatus, comprising:
(a) an attachment means for releasably securing the apparatus to a vehicle;
(b) a platform connected to the attachment means and movable between a lowered loading position and a raised hauling position;
(c) at least one support member for connecting the platform to the attachment means, the at least one support member being adapted to vary a distance between the platform and the attachment means; and
(d) a moving means for moving the platform between the lowered loading position and the raised hauling position.

2. The lifting and hauling apparatus according to claim 1, wherein the attachment means is adapted to be received in a hitch of the vehicle.

3. The lifting and hauling apparatus according to claim 1, wherein the platform is pivotally connected to the at least one support member.

4. The lifting and hauling apparatus according to claim 3, and further including an adjustment member pivotally connected to the platform for selectively pivoting the platform relative to the at least one support member.

5. The lifting and hauling apparatus according to claim 1, wherein the platform is connected to at least one adjustment member for selectively pivoting the platform relative to the attachment means.

6. The lifting and hauling apparatus according to claim 1, wherein the platform is adapted to be secured to the vehicle while in the hauling position.

7. A lifting and hauling apparatus for being mounted to a vehicle, comprising:
(a) a platform assembly, including:
(i) an attachment member adapted to be releasably secured to the vehicle;
(ii) at least one support member carried by and moveable relative to the attachment member;
(iii) a platform carried by the support member and adapted for hauling items thereupon; and
(b) a lifting assembly operably connected to the platform assembly and adapted to be connected to the vehicle for moving the platform between a lowered loading position and a raised hauling position.

8. The lifting and hauling apparatus according to claim 7, wherein the attachment member is adapted to be received in a hitch of the vehicle.

9. The lifting and hauling apparatus according to claim 7, wherein the lifting assembly includes a winch for moving the platform between the loading position and the hauling position.

10. The lifting and hauling apparatus according to claim 9, wherein the winch is releasably secured to a hitch of the vehicle.

11. The lifting and hauling apparatus according to claim 7, wherein the platform is pivotally connected to the at least one support member and moveable relative thereto.

12. The lifting and hauling apparatus according to claim 7, and further including an adjustment member having a first end pivotally connected to the platform and a second end for being releasably secured to the at least one support member, the adjustment member being adapted to selectively pivot the platform relative to the at least one support member.

13. The lifting and hauling apparatus according to claim 7, wherein the at least one support member includes an inner member slidably engaged with an outer member to allow the at least one support member to be adjusted in length.

14. A lifting and hauling apparatus for being mounted to a vehicle, comprising:
(a) a platform assembly, including:
(i) an attachment member adapted to be received into an opening of a hitch of the vehicle;
(ii) at least one support member connected to the attachment member;
(iii) a platform carried by the at least one support member and adapted for hauling items thereupon; and
(b) a lifting assembly operably connected to the platform assembly and adapted to be connected to the vehicle for moving the platform between a lowered loading position and a raised hauling position, including:
(i) a winch carried by the hitch;
(ii) a pulley assembly carried by the vehicle; and
(iii) a cable extending through the pulley assembly and interconnecting the platform and the winch, whereby the winch is adapted to manipulate the cable to move the platform between the raised hauling position and the lowered loading position.

15. The lifting and hauling apparatus according to claim 14, wherein the at least one support member includes an inner member slidably engaged with an outer member to allow the at least one support member to be adjusted to a desired length.

16. The lifting and hauling apparatus according to claim 15, wherein at least one of the inner and outer members includes a plurality of apertures for allowing a fastener to pass therethrough and secure the inner member to the outer member.

17. The lifting and hauling apparatus according to claim 14, and further including an adjustment member having a first end pivotally connected to the platform and a second end for being releasably secured to the at least one support member, the adjustment member being adapted to selectively pivot the platform relative to the at least one support member.

18. The lifting and hauling apparatus according to claim 17, wherein the second end of the adjustment member includes a plurality of apertures for being aligned with an aperture in the at least one support member and secured thereto by a fastener passing through the aligned apertures so as to allow the platform to be selectively pivoted with respect to the at least one support member.

19. The lifting and hauling apparatus according to claim 14, wherein the platform is concave in shape.

20. The lifting and hauling apparatus according to claim 19, wherein the platform further includes a tube frame surrounding a mesh surface.

21. The lifting and hauling apparatus according to claim 14, wherein the attachment member is adapted to slide into the opening of the hitch and the winch is adapted to slide over the hitch such that at least one aperture on the winch, hitch, and attachment member are aligned and adapted to receive a fastener therethrough.

22. The lifting and hauling apparatus according to claim 14, wherein the at least one support member is pivotally connected to the attachment member by a transverse member to allow the support member to move relative to the attachment member.

23. The lifting and hauling apparatus according to claim 14, wherein the pulley assembly is adapted to be attached to the vehicle at a location above the winch so as to allow the winch to move the platform to the hauling position.

24. The lifting and hauling apparatus according to claim 14, wherein the platform is adapted to receive a hook, the hook being connected to an end of the cable opposite of the winch for releasably connecting the platform to the winch using the cable and allowing the winch to move the platform between the loading and hauling positions.
